(19) United States
(12) Patent Application Publication
(10) Pub. No.: US 2024/0338670 A1
(43) Pub. Date: Oct. 10, 2024

(54) INFORMATION PROCESSING APPARATUS, POINT-OF-SALE SYSTEM, AND METHOD

(71) Applicant: Toshiba Tec Kabushiki Kaisha, Tokyo (JP)

(72) Inventor: Tomotake NIINO, Izunokuni Shizuoka (JP)

(21) Appl. No.: 18/595,186

(22) Filed: Mar. 4, 2024

(30) Foreign Application Priority Data
Apr. 7, 2023 (JP) 2023-062529

(51) Int. Cl. G06Q 20/20; G06F 3/14

(52) U.S. Cl. CPC G06Q 20/206; G06F 3/14

(57) ABSTRACT

An information processing apparatus includes a connection interface connectable to an external device and a peripheral device, a display, an input interface, and a processor configured to start an operation system, and when the operation system is started or the peripheral device is connected to the connection interface, execute a first application, which causes the display to continuously display a first operation screen in full screen mode before displaying a second operation screen of the operation system or another application installed in the information processing apparatus.

### CROSS-REFERENCE TO RELATED APPLICATION(S)

This application is based upon and claims the benefit of priority from Japanese Patent Application No. 2023-062529, filed Apr. 7, 2023, the entire contents of which are incorporated herein by reference.

### FIELD

Embodiments described herein relate generally to an information processing apparatus, a point-of-sale (POS) system, and a method.

### BACKGROUND

A tablet POS system is known in which a POS application for implementing a POS function is installed in a portable terminal, such as a tablet terminal, that is lightweight, space-saving, and portable. In many cases, such a portable terminal does not have an I/O port for connection to a peripheral device such as a printer or an automatic change machine. For this reason, an information processing apparatus, such as an IO-BOX, with multiple I/O ports is used to add I/O ports to the portable terminal.

Under such circumstances, a touch panel display may be provided in an IO-BOX to, for example, improve operability and functionality or to share a component with another device and thereby reduce development costs. In this case, there is a risk that unauthorized operations, such as starting unnecessary tools and changing operating system (OS) settings, are performed through the operation screen of the IO-BOX.

### SUMMARY OF THE INVENTION

An aspect of this disclosure makes it possible to prevent unauthorized operations from being performed on operation screens of an information processing apparatus that connects a portable POS terminal to peripheral devices.

According to an aspect of this disclosure, an information processing apparatus comprises a connection interface connectable to an external device and a peripheral device; a display; an input interface; and a processor configured to: start an operation system, and when the operation system is started or the peripheral device is connected to the connection interface, execute a first application, which causes the display to continuously display a first operation screen in full screen mode before displaying a second operation screen of the operation system or another application installed in the information processing apparatus.

### BRIEF DESCRIPTION OF THE DRAWINGS

FIG. 1 is a block diagram illustrating a configuration of a POS system according to an embodiment.

FIG. 2 is a schematic diagram illustrating an external appearance of a peripheral device control apparatus of the POS system.

FIG. 3 is a block diagram illustrating a hardware configuration of the peripheral device control apparatus.

FIG. 4 is a block diagram illustrating a functional configuration of the peripheral device control apparatus.

FIGS. 5A and 5B are parts of a flowchart illustrating a process performed by the peripheral device control apparatus.

FIG. 6 is a diagram illustrating an example of a cover screen displayed in the process of FIG. 5A.

FIG. 7 is a diagram illustrating an example of an authentication screen displayed in the process of FIG. 5B.

### DETAILED DESCRIPTION

Hereinafter, an information processing apparatus, a POS system, and a method according to embodiments of this disclosure will be described with reference to the drawings. However, embodiments of this disclosure are not limited to the embodiments described below. In the embodiments described below, it is assumed that the present disclosure is applied to a POS system in a store, such as a supermarket.

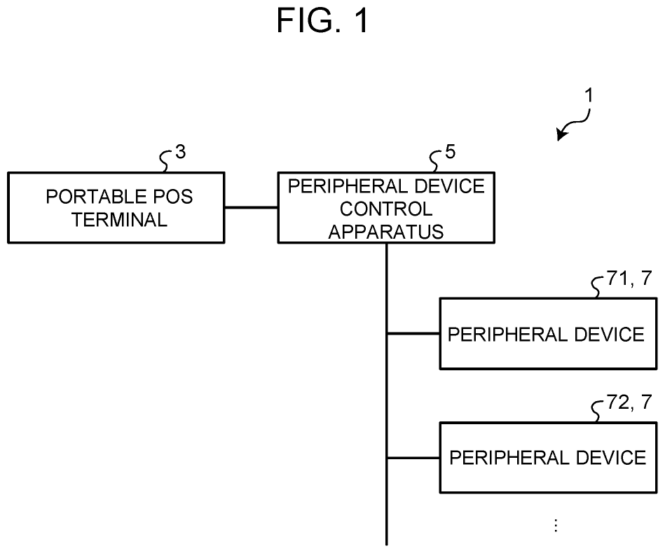

FIG. 1 is a block diagram illustrating a configuration of a POS system 1 according to the embodiment. As illustrated in FIG. 1, the POS system 1 includes a portable POS terminal 3, a peripheral device control apparatus 5, and peripheral devices 7.

Although FIG. 1 illustrates two peripheral devices 71 and 72 as the peripheral devices 7, the number of peripheral devices 7 is not limited to two. The POS system 1 may include one peripheral device 7 or three or more peripheral devices 7. That is, the POS system according to the embodiment includes at least one peripheral device 7.

The POS system 1 according to the embodiment is an example of an information processing system. The portable POS terminal 3 according to the embodiment is an example of an external device. The peripheral device control apparatus 5 according to the embodiment is an example of an information processing apparatus.

In the POS system 1, the portable POS terminal 3 is connected to the peripheral device control apparatus 5 so as to be able to communicate with the peripheral device control apparatus 5 by wire or wirelessly. Note that the communication between the portable POS terminal 3 and the peripheral device control apparatus 5 may be performed via a communication device, such as an access point, or via a network, such as a local area network (LAN), in a store.

Furthermore, in the POS system 1, the peripheral devices 7 are connected to the peripheral device control apparatus 5 so as to be able to communicate with the peripheral device control apparatus 5 by wire or wirelessly. The communication between the peripheral device control apparatus 5 and the peripheral devices 7 may be performed via a communication device, such as an access point, or via a network, such as a LAN, in a store.

The portable POS terminal 3 is a portable terminal device configured to implement a POS function for performing an item registration process and a payment process. The portable POS terminal 3 is, for example, a portable terminal device, such as a tablet personal computer (PC) or a smart phone, and is carried by a store clerk in a store.

For example, the portable POS terminal 3 is configured to execute a POS application. Specifically, the portable POS terminal 3 implements a POS function by executing a program (a POS application program) stored in an internal memory (not shown) with a processor (not shown).

For example, the portable POS terminal 3 is configured to be connectable to the peripheral device control apparatus 5 in a first connection mode. Specifically, the portable POS terminal 3 includes a connection unit for connection with the peripheral device control apparatus 5 in the first connection mode. The connection unit is, for example, a communication interface (I/F) for wireless communication. Alternatively, the connection unit may be a communication I/F using a connector for connecting a general-purpose cable conforming to any standard such as a universal serial bus (USB) standard, an ANSI/EIA/TIA-232-F standard, or an Ethernet (registered trademark) standard.

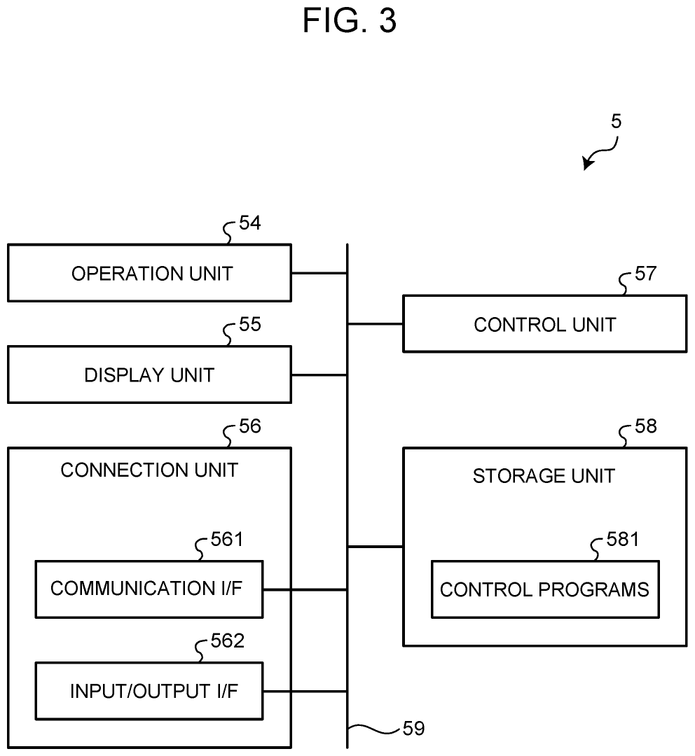

The peripheral device control apparatus 5 is an information processing apparatus (IO-BOX) for expanding (adding) I/O ports available for the portable POS terminal 3. The peripheral device control apparatus 5 includes a connection unit 56 (see FIG. 3) that connects the peripheral device control apparatus 5 to the portable POS terminal 3 and the peripheral devices 7 to enable communication. The peripheral device control apparatus 5 relays communication between the portable POS terminal 3 and the peripheral devices 7. Details of the peripheral device control apparatus 5 will be described later.

The peripheral devices 7 are configured to be connectable to the peripheral device control apparatus 5 in a second connection mode. The peripheral devices 7 are various types of information processing devices configured to be able to cooperate with the portable POS terminal 3 via the peripheral device control apparatus 5. For example, each peripheral device 7 may be configured to operate in response to an operation request sent from the portable POS terminal 3 via the peripheral device control apparatus 5. Also, for example, the peripheral device 7 may be configured to output, as a result of the operation, information or an operation request to the portable POS terminal 3 via the peripheral device control apparatus 5.

As an example, the peripheral device 7 implements its function by executing a control program stored in an internal memory (not shown) with a processor (not shown).

As an example, the peripheral device 7 includes a connection unit for connection with the peripheral device control apparatus 5 in the second connection mode. The connection unit is, for example, an input/output I/F that uses a connector (or an I/O port) for connecting a general-purpose cable or a dedicated cable conforming to a standard such as a USB standard, an ANSI/EIA/TIA-232-F standard, or an Ethernet (registered trademark) standard. Alternatively, the connection unit may be an input/output I/F for transmitting and/or receiving data via wireless communication.

For example, the peripheral device 7 may be a printer that prints a slip, such as a receipt, or a label in response to an operation request sent from the portable POS terminal 3 via the peripheral device control apparatus 5.

As an example, the peripheral device 7 may be an automatic change machine that stores and pays out cash in response to an operation request sent from the portable POS terminal 3 via the peripheral device control apparatus 5.

As an example, the peripheral device 7 may be a drawer that stores cash (money) and opens and closes, or operates an opening/closing lock mechanism, in response to an operation request sent from the portable POS terminal 3 via the peripheral device control apparatus 5.

As an example, the peripheral device 7 may be a code reader that reads code information, such as item information, from a code symbol such as a barcode or a two-dimensional code and outputs a reading result via the peripheral device control apparatus 5 in response to an operation request sent from the portable POS terminal 3 via the peripheral device control apparatus 5 or in response to an operation performed by an operator on the peripheral device 7.

As an example, the peripheral device 7 may be a card reader that reads card information from a magnetic card or an IC card in a contact or non-contact manner and outputs a reading result via the peripheral device control apparatus 5 in response to an operation request sent from the portable POS terminal 3 via the peripheral device control apparatus 5 or in response to an operation performed by an operator on the peripheral device 7.

As an example, the peripheral device 7 may be an input device such as a keyboard or a mouse that outputs an input result via the peripheral device control apparatus 5 in response to an operation by an operator on the peripheral device 7.

Note that some of the functions of the peripheral devices 7 may be provided in the peripheral device control apparatus 5. That is, the peripheral device control apparatus 5 may be configured as a function extension device that enables the portable POS terminal 3 to use the functions of the peripheral device control apparatus 5 and/or the functions of the peripheral devices 7 connected to the peripheral device control apparatus 5.

In the POS system 1 according to the present embodiment, the connection mode (second connection mode) between the peripheral device control apparatus 5 and the peripheral devices 7 differs from the connection mode (first connection mode) between the portable POS terminal 3 and the peripheral device control apparatus 5. That is, at least one peripheral device 7, which cannot be directly connected to the portable POS terminal 3, is connected to the peripheral device control apparatus 5. Also, a peripheral device 7, which can be directly connected to the portable POS terminal 3, may be connected to the peripheral device control apparatus 5. Furthermore, the connection mode between the peripheral device control apparatus 5 and the peripheral device 71 may be different from or the same as the connection mode between the peripheral device control apparatus 5 and the peripheral device 72.

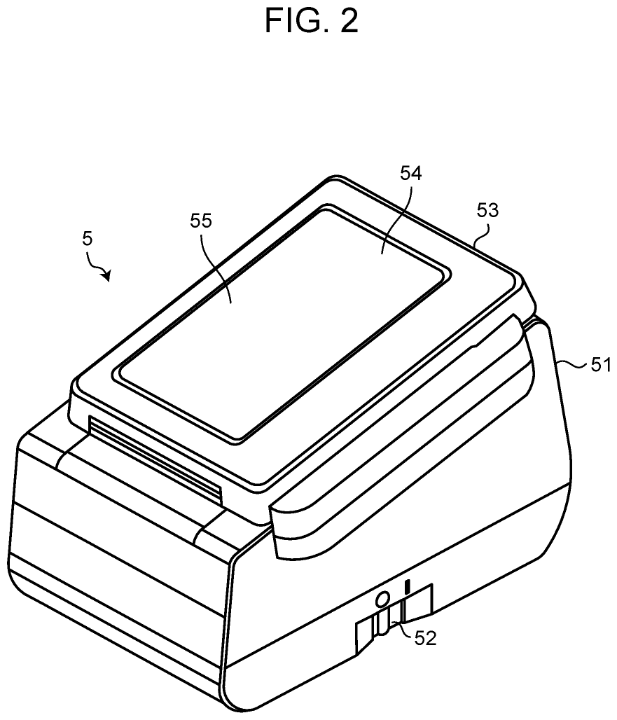

A hardware configuration of the peripheral device control apparatus 5 is described below with reference to the drawings. FIG. 2 is a schematic diagram illustrating an external appearance of the peripheral device control apparatus 5 according to the embodiment. FIG. 3 is a block diagram illustrating a hardware configuration of the peripheral device control apparatus 5 according to the embodiment.

As shown in FIG. 2, the housing of the peripheral device control apparatus 5 includes a main body 51 and a top panel 53 that can be opened and closed with respect to the main body 51. The peripheral device control apparatus 5 includes a power switch 52, an operation unit 54, and a display unit 55.

As shown in FIG. 2, the power switch 52 is provided, for example, in a lower portion of a side surface of the main body 51. The power switch 52 is an on-off switch. When the operator turns on the power switch 52, a power supply line is connected, and power is supplied from a built-in battery to components of the main body 51 and the peripheral devices 7. When the operator turns off the power switch 52, the power supply line is disconnected, the supply of power is stopped, and the peripheral device control apparatus 5 is forcibly shut down. The power switch 52 may also be implemented as a power button that connects and disconnects the power supply line when pressed by the operator.

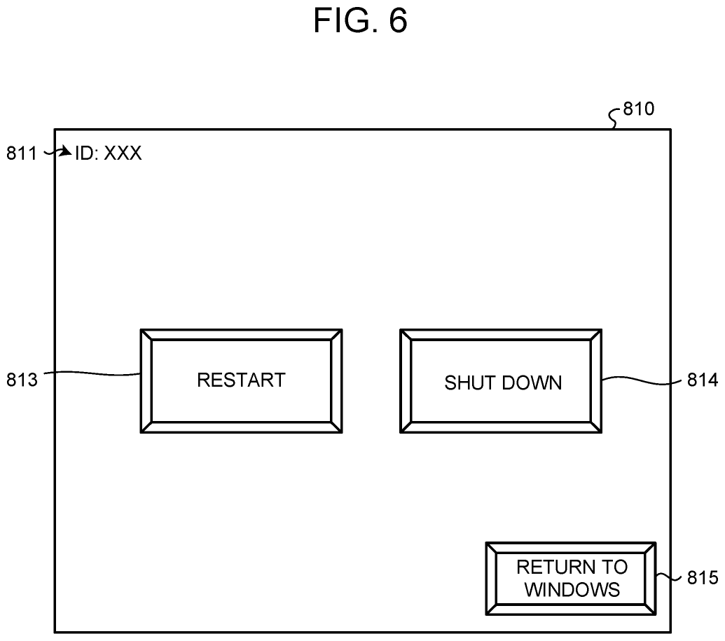

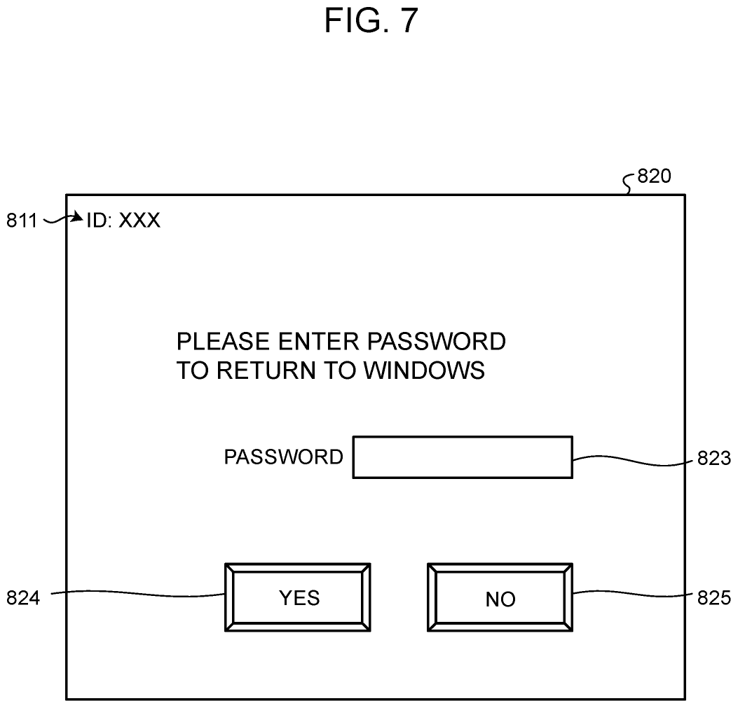

As illustrated in FIG. 2, the operation unit 54 is provided, for example, on the top panel 53. The operation unit 54 is an input interface that receives an input operation from a user. The operation unit 54 is, for example, a touch panel that is disposed on a display surface (screen) of the display unit 55, detects a touch operation performed by an operator, and outputs a signal to a control unit 57 (see FIG. 3). As an example, the operation unit 54 is configured to receive input operations performed by an operator on operation screens (see FIGS. 6 and 7) displayed on the display unit 55. The operation unit 54 may also include various input devices such as a keyboard, switches, and buttons.

As illustrated in FIG. 2, the display unit 55 is provided, for example, on the top panel 53. The display unit 55 is a display configured to display various screens generated under the control of the control unit 57. As an example, the display unit 55 is configured to display operation screens (see FIGS. 6 and 7) under the control of the control unit 57. The display unit 55 may be implemented by, for example, a liquid crystal display (LCD) or an organic electro-luminescence (EL) display.

As illustrated in FIG. 3, the peripheral device control apparatus 5 further includes a connection unit 56, a control unit 57, and a storage unit 58. The connection unit 56, the control unit 57, and the storage unit 58 are provided in a housing of, for example, the main body 51 or the top panel 53, or provided on a surface (back surface) of the top panel 53 that is opposite the surface on which the display unit 55 is provided. The operation unit 54, the display unit 55, the connection unit 56, the control unit 57, and the storage unit 58 are connected via a bus 59 or the like to be able to communicate with each other.

The connection unit 56 is connected to and is able to communicate with the portable POS terminal 3 and the peripheral devices 7 for the portable POS terminal 3. The connection unit 56 is a connection interface configured to relay communication between the portable POS terminal 3 and the peripheral devices 7. Specifically, the connection unit 56 includes a communication I/F 561 and an input/output I/F 562. The communication I/F 561 is an example of a first connection interface. The input/output I/F 562 is an example of a second connection interface.

The communication I/F 561 is a wireless communication interface that connects the peripheral device control apparatus 5 to the portable POS terminal 3 to enable communication in the first connection mode. The peripheral device control apparatus 5 transmits and receives various types of information to and from the portable POS terminal 3 via the communication I/F 561. The communication I/F 561 may instead be a wired communication interface for wired communication with the portable POS terminal 3. In this case, a connector (or a communication port) for wired connection of the communication I/F 561 may be provided, for example, on the rear surface of the main body 51.

The input/output I/F 562 is a connection interface having a connector (or an I/O port) for connecting the peripheral device 7 to the peripheral device control apparatus 5 to enable communication in the second connection mode. Multiple input/output I/Fs 562 are provided. Various types of peripheral devices 7 can be detachably connected to the multiple input/output I/Fs 562. The peripheral device control apparatus 5 transmits and receives various types of information to and from the peripheral devices 7 by using the input/output I/Fs 562. Connectors (or I/O ports) of the input/output I/Fs 562 may be provided, for example, on the rear surface of the main body 51.

The control unit 57 includes a processor such as a central processing unit (CPU) and memory such as a read-only memory (ROM) and a random access memory (RAM). The processor and the memory of the control unit 57 are connected via an internal bus to be able to communicate with each other. For example, the control unit 57 may have a configuration of a general computer and may be configured to load various programs stored in the ROM and the storage unit 58 into the RAM and control the operations of the components of the peripheral device control apparatus 5 by executing the loaded programs with the processor.

The control unit 57 may include any other type of processor instead of or in addition to the CPU. Examples of other processors include a graphics processing unit (GPU), a digital signal processor (DSP), and dedicated arithmetic circuits such as an application specific integrated circuit (ASIC) and a field programmable gate array (FPGA).

The storage unit 58 is a storage device with a non-volatile storage medium such as a hard disk drive (HDD) or a solid state drive (SSD). The storage unit 58 stores various programs and various types of data related to the operations of the peripheral device control apparatus 5, device drivers of the peripheral devices 7, and the like.

As an example, the storage unit 58 stores control programs 581. For example, the control programs 581 include firmware such as a basic input output system (BIOS) for starting an operating system (OS) for controlling the entire peripheral device control apparatus 5. As an example, the control programs 581 include programs for implementing functional units of the peripheral device control apparatus 5 described later. As an example, the control programs 581 include application programs to be executed by the functional units described later. The application programs include a cover application, a connection application, and an application executed in a maintenance and management process described later.

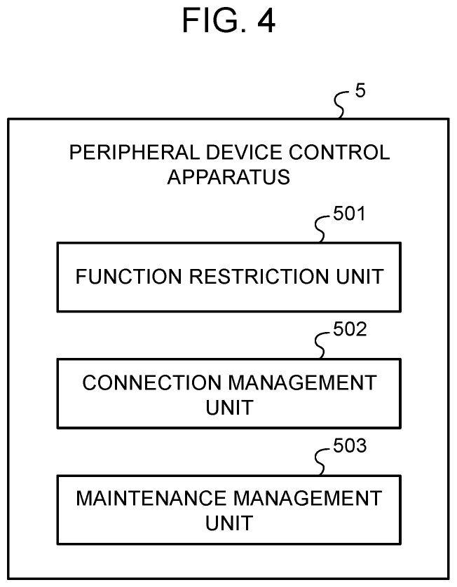

A functional configuration of the peripheral device control apparatus 5 will be described with reference to the drawing. FIG. 4 is a block diagram illustrating a functional configuration of the peripheral device control apparatus 5 according to the embodiment.

The control unit 57 implements a function restriction unit 501, a connection management unit 502, and a maintenance management unit 503, as illustrated in FIG. 4, by executing the control programs 581 loaded into the memory.

The function restriction unit 501 is configured to execute a cover application, which causes the display unit 55 to continuously display a cover screen 810 (see FIG. 6) in full screen mode, when the peripheral device control apparatus 5 is started (in other words, at the startup of the peripheral device control apparatus 5). Here, the cover application according to the embodiment is an example of a first application. The cover screen 810 displayed by the cover application according to the embodiment is an example of a first operation screen.

As an example, the peripheral device control apparatus 5 is configured such that the cover application is executed when the peripheral device control apparatus 5 is started. In this case, the function restriction unit 501 executes the cover application when the peripheral device control apparatus 5 is started. With this configuration, the function restriction unit 501 starts continuously displaying the cover screen 810 in full screen mode after the peripheral device control apparatus 5 is started and before an operation screen for receiving an input operation from an operator is displayed on the display unit 55 by any application other than the cover application or by an operating system (OS) of the peripheral device control apparatus 5.

As an example, when the operation unit 54 receives an operation of a “return to Windows” button 815 (see FIG. 7) on the cover screen 810, the function restriction unit 501 causes the display unit 55 to display an authentication screen 820 (see FIG. 7) for authenticating the operator. When the operator is authenticated, the function restriction unit 501 stops the continuous full-screen display of the cover screen 810. Here, the “return to Windows” button 815 according to the embodiment is an example of the operation unit 54 for requesting the execution of an application other than the cover application or requesting to make settings of the OS, and is an example of a third operation button. The authentication screen 820 according to the embodiment is an example of a second operation screen.

The function restriction unit 501 may be configured to stop the continuous full-screen display by, for example, terminating the cover application. Alternatively, the cover application may include a function to stop the continuous full-screen display.

The connection management unit 502 manages communication between the portable POS terminal 3 and the peripheral devices 7. Specifically, the connection management unit 502 is configured to execute a connection application for managing the connection between the peripheral devices 7 and the portable POS terminal 3 while the cover screen 810 is being continuously displayed. Note that the connection application may be implemented as a function of the OS. Here, the connection application according to the embodiment is an example of a second application.

For example, the connection management unit 502 transmits and receives various types of information to and from the portable POS terminal 3 via the communication I/F 561.

For example, the connection management unit 502 receives an operation request related to a peripheral device 7 from the portable POS terminal 3. Also, for example, the connection management unit 502 causes the peripheral device 7 specified in the operation request to perform a requested operation via the input/output I/F 562. In addition, for example, the connection management unit 502 transmits an operation result of the peripheral device 7 in response to the operation request to the portable POS terminal 3.

For example, when an operation result such as an input from the operator is received from the peripheral device 7 via the input/output I/F 562, the connection management unit 502 transmits the operation result to the portable POS terminal 3 via the communication I/F 561.

When the operator is authenticated on the authentication screen 820, the maintenance management unit 503 executes a maintenance and management process. Here, the maintenance management unit 503 according to the embodiment is an example of an execution unit.

For example, in the maintenance and management process, the maintenance management unit 503 receives an input operation that is performed by the operator on the operation unit 54 and related to the execution of an application other than the cover application or to the setting of the OS.

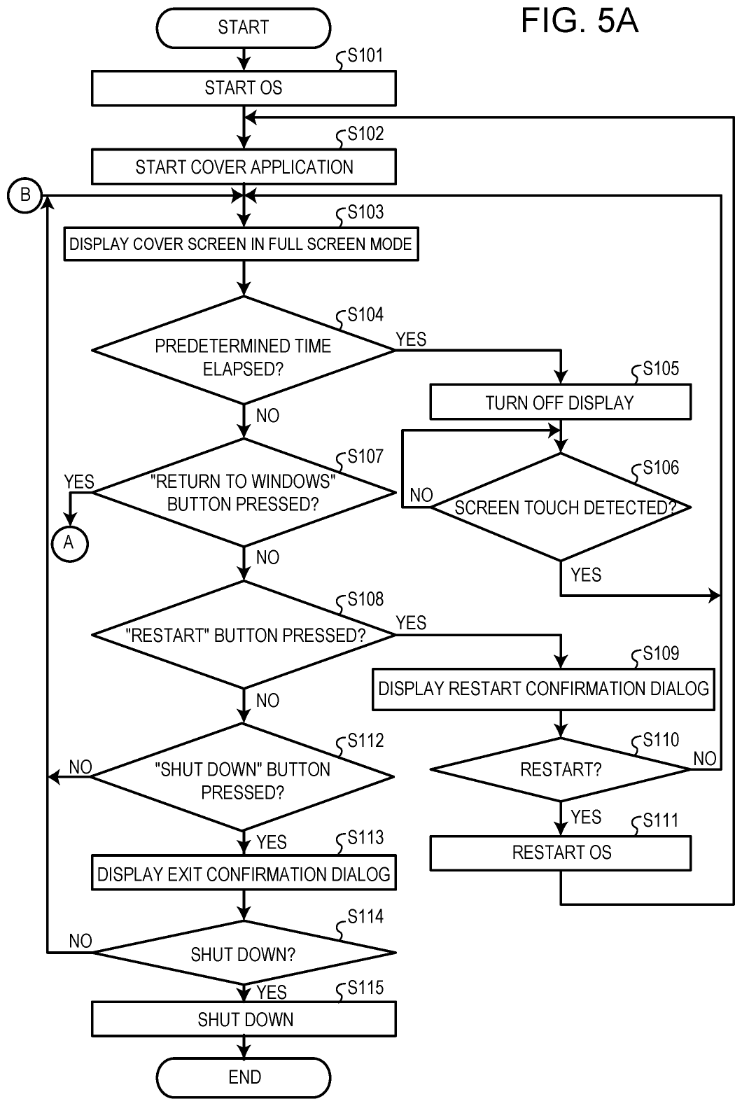

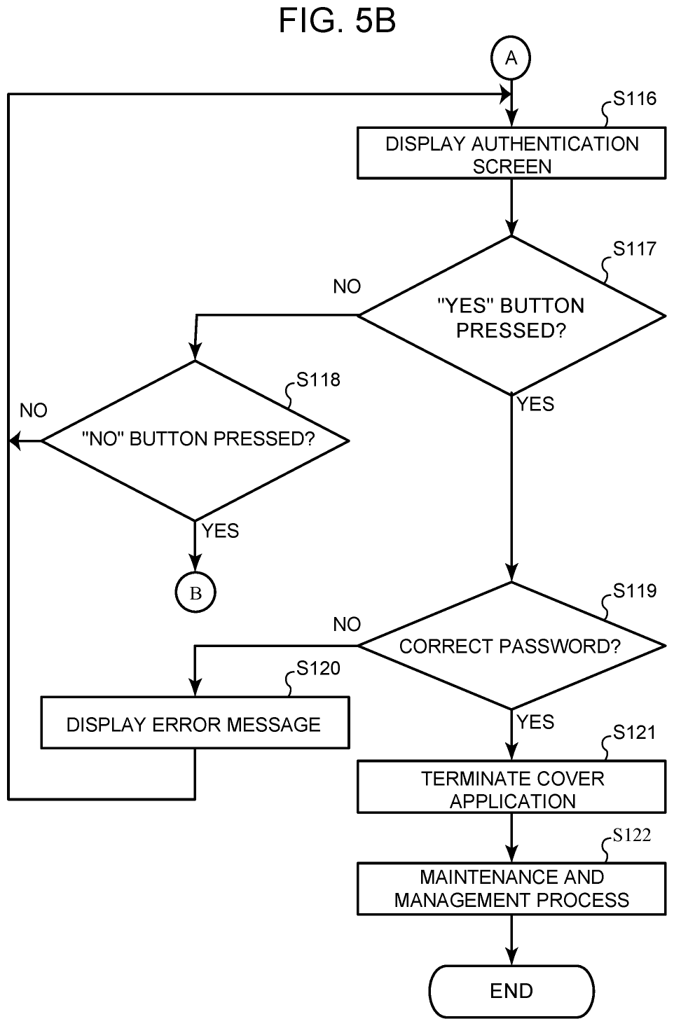

Operations of the POS system 1 having the above-described configuration will now be described. FIGS. 5A and 5B are parts of a flowchart illustrating a process executed in the peripheral device control apparatus 5 according to the embodiment. In the descriptions below, FIGS. 5A and 5B may be collectively referred to as FIG. 5. The process illustrated in FIG. 5 is merely an example. Steps may be added to and removed from the process illustrated in FIG. 5, and the order of the steps in the process may be changed. For example, the order in which the pressing operations of operation buttons are detected may be changed.

The control unit 57 starts the peripheral device control apparatus 5 when, for example, the power switch 52 is turned on. Specifically, the control unit 57 starts an OS (for example, Windows (registered trademark)) of the peripheral device control apparatus 5 by executing firmware such as a BIOS stored in a memory such as the ROM (S101). Next, the function restriction unit 501 starts the cover application (S102) to continuously display the cover screen 810 in full screen mode in the foreground of the display unit 55 (S103). Also, at this step, a program (or a connection application) for connection management is executed by the connection management unit 502.

FIG. 6 is a diagram illustrating the cover screen 810 displayed in a process executed by the peripheral device control apparatus 5. The cover screen 810 includes an ID 811 that uniquely identifies an operator who has logged in. The cover screen 810 also includes a “restart” button 813 and a “shut down” button 814. Here, the “restart” button 813 according to the embodiment is an example of the operation unit 54 for requesting the restart of the peripheral device control apparatus 5 and is an example of a first operation button. Also, the “shut down” button 814 according to the embodiment is an example of the operation unit 54 for requesting the power-off or the shutdown of the peripheral device control apparatus 5 and is an example of a second operation button. In addition, the cover screen 810 includes a “return to Windows” button 815.

As described above, in the peripheral device control apparatus 5 according to the embodiment, the continuous full-screen display of the cover screen 810 is started at the startup of the peripheral device control apparatus 5. In the peripheral device control apparatus 5, the login (or logon) to the OS may be performed automatically, that is, without requiring an input from the operator, or performed manually. Also, in the peripheral device control apparatus 5 according to the embodiment, after the login to the OS, the cover application is started by, for example, a task scheduler, and the continuous full-screen display of the cover screen 810 is thereby started. That is, the continuous full-screen display of the cover screen 810 is started at the startup of the peripheral device control apparatus 5. Specifically, the continuous full-screen display of the cover screen 810 is started after the login to the OS and before any other application different from the cover application is started and enabled to receive input operations on the operation screens of the display unit 55 so that operations on the other application or the OS are disabled. The operation buttons on the cover screen 810 enable the operator to restart and shut down the peripheral device control apparatus 5 and to terminate the cover application, as will be described below.

The function restriction unit 501 determines whether a predetermined time has elapsed from the start or resumption of the continuous full-screen display of the cover screen 810 or from the latest operation performed by the operator (S104). The predetermined time may be set at any appropriate value and stored in, for example, an internal memory of the control unit 57 or the storage unit 58 in advance.

When the predetermined time has elapsed (S104: Yes), the function restriction unit 501 turns off the screen of the display unit 55, that is, turns off the display (S105). Then, the function restriction unit 501 waits until the operator performs an operation, or a screen touch, on the operation unit 54 (S106: No). On the other hand, when a screen touch is detected (S106: Yes), the process of FIG. 5 returns to step S103, and the continuous full-screen display of the cover screen 810 is resumed.

As described above, in the peripheral device control apparatus 5 according to the embodiment, when there is no operation for a predetermined time, to prevent the operation screen of the cover application from being continuously displayed, the backlight of the display is turned off to interrupt the display of the cover screen 810; and when an operation is performed on the screen by the operator, the backlight is turned on again to resume the display of the cover screen 810. This configuration makes it possible to reduce the power consumption. Also, this configuration makes it possible to prevent the operator from being prompted by the displayed screen to perform an unnecessary operation and thereby prevent unauthorized operations.

On the other hand, when the predetermined time has not elapsed (S104: No), the function restriction unit 501 determines whether the “return to Windows” button 815 has been pressed (S107). When the “return to Windows” button 815 has not been pressed (S107: No), the function restriction unit 501 determines whether the “restart” button 813 has been pressed (S108).

When the “restart” button 813 has been pressed (S108: Yes), the function restriction unit 501 displays a restart confirmation dialog on the display unit 55 (S109) and determines whether to restart the peripheral device control apparatus 5 (or the OS) (S110).

When it is determined to restart the peripheral device control apparatus 5 (S110: Yes), the function restriction unit 501 restarts the peripheral device control apparatus 5 (S111). Then, the process of FIG. 5 returns to step S102. On the other hand, when it is not determined to restart the peripheral device control apparatus 5 (S110: No), the process of FIG. 5 returns to step S103.

When the “restart” button 813 has not been pressed (S108: No), the function restriction unit 501 determines whether the “shut down” button 814 has been pressed (S112).

When the “shut down” button 814 has been pressed (S112: Yes), the function restriction unit 501 displays an exit confirmation dialog on the display unit 55 (S113) and determines whether to shut down the peripheral device control apparatus 5 (S114).

When it is determined to shut down the peripheral device control apparatus 5 (S114: Yes), the function restriction unit 501 shuts down the peripheral device control apparatus 5 (S115), and the process of FIG. 5 is terminated. On the other hand, when it is not determined to shut down the peripheral device control apparatus 5 (S114: No), the process of FIG. 5 returns to step S103.

Each of the restart confirmation dialog (S109) and the exit confirmation dialog (S113) is displayed as a pop-up window on a screen of the display unit 55, such as the cover screen 810, but may instead be displayed in full screen mode similarly to the cover screen 810. Also, for example, the function restriction unit 501 may be configured to determine whether to restart or shut down the peripheral device control apparatus 5 based on an input operation performed by the operator on the corresponding confirmation dialog. For example, each confirmation dialog may include operation buttons (or the operation unit 54) such as a “Yes” button and a “No” button. The function restriction unit 501 may be configured to determine not to restart or shut down the peripheral device control apparatus 5 based not only on an operation performed by the operator on the operation buttons but also on whether a predetermined time has elapsed after the confirmation dialog is displayed. The predetermined time is set in advance and stored in, for example, the internal memory of the control unit 57 or the storage unit 58.

As described above, in the peripheral device control apparatus 5 according to the embodiment, when the “restart” button 813 or the “shut down” button 814 is pressed, a confirmation dialog is displayed; and when “Yes” is selected, the peripheral device control apparatus 5 is restarted or shut down.

When the “return to Windows” button 815 is pressed (S107: Yes), the function restriction unit 501 displays the authentication screen 820 on the display unit 55 (S116).

FIG. 7 is a diagram illustrating the authentication screen 820 displayed in a process executed by the peripheral device control apparatus 5. The authentication screen 820 includes an ID 811 that uniquely identifies an operator who has logged in. The authentication screen 820 also includes a password input field 823, a “Yes” button 824, and a “No” button 825. The password input field 823 is an example of the operation unit 54 for inputting a password for authentication of the operator. In addition, the authentication screen 820 may display a message such as “Please enter password to return to Windows” together with the password input field 823. In the present embodiment, it is assumed that password authentication is performed. However, any other authentication method, such as biometric authentication or multifactor authentication, may be performed instead of password authentication. The “Yes” button 824 is an example of the operation unit 54 for requesting password authentication. For example, the operator presses the “Yes” button 824 after inputting the password. The “No” button 825 is an example of the operation unit 54 for canceling password authentication, that is, for closing the authentication screen 820. For example, the operator presses the “No” button 825 to cancel or terminate password authentication.

The authentication screen 820 may be displayed in full screen mode as in the case of the cover screen 810, or may be displayed as a pop-up window over the cover screen 810.

After the authentication screen 820 is displayed, the function restriction unit 501 may turn on and off the display of the authentication screen 820 based on whether an operation has not been performed for a predetermined time, in a manner similar to steps S104 through S106.

After the authentication screen 820 is displayed, the function restriction unit 501 determines whether the “Yes” button 824 has been pressed (S117). When the “Yes” button 824 has not been pressed (S117: No), the function restriction unit 501 determines whether the “No” button 825 has been pressed (S118). When the “No” button 825 has been pressed (S118: Yes), the process of FIG. 5 returns to step S103. On the other hand, when the “No” button 825 has not been pressed, the process of FIG. 5 returns to step S116.

When the “Yes” button 824 has been pressed (S117: Yes), the function restriction unit 501 determines whether a correct password has been entered (S119). When a correct password has not been entered (S119: No), the function restriction unit 501 displays an error message on the display unit 55 (S120). The error message may be displayed on the screen of the display unit 55, for example, as a pop-up window over the authentication screen 820. Alternatively, the error message may be displayed in full screen mode similarly to the cover screen 810. Then, the process of FIG. 5 returns to step S116.

On the other hand, when a correct password has been entered (S119: Yes), the function restriction unit 501 terminates the cover application (S121). That is, after the password authentication, the function restriction unit 501 stops the continuous full-screen display of the cover screen 810 by terminating the cover application.

As described above, in the peripheral device control apparatus 5 according to the embodiment, when the “return to Windows (registered trademark)” button is pressed, the authentication screen 820 for entering a password is displayed; and when a correct password is entered on the authentication screen 820, the cover application is terminated.

After the cover application is terminated, the maintenance management unit 503 executes a maintenance and management process according to input operations performed by the operator on the operation unit 54 (S122). As described above, the maintenance and management process is executed after the cover application is terminated, that is, in a state in which operations are not disabled by the cover screen 810. After the maintenance and management process, the process of FIG. 5 ends.

For example, the peripheral device control apparatus 5 is configured, by default, to execute the cover application when the peripheral device control apparatus 5 is started. However, the present disclosure is not limited to this example. As another example, the peripheral device control apparatus 5 may be configured to execute the cover application in response to the connection (or attachment) of the peripheral device 7 to the peripheral device control apparatus 5. In this case, the function restriction unit 501 executes the cover application when the peripheral device 7 is connected to the peripheral device control apparatus 5 so that the continuous full-screen display of the cover screen 810 is started after the peripheral device 7 is connected and before an operation screen for receiving an input operation from the operator is displayed on the display unit 55 by any application other than the cover application or by the OS.

For example, the peripheral device control apparatus 5 may be configured to stop the continuous full-screen display of the cover screen 810 when the peripheral device 7 is not connected to (or disconnected from) the peripheral device control apparatus 5. In this case, the maintenance management unit 503 executes the maintenance and management process in a manner similar to the case in which authentication is performed on the authentication screen 820.

The continuous full-screen display of the cover screen 810 may be resumed in response to the connection of the peripheral device 7 or may be resumed in response to an operation performed by an authenticated user in the maintenance and management process.

In the present embodiment, a maintenance and management process is performed as a process related to the execution of an application other than the cover application or to the setting of the OS when the operator is authenticated on the authentication screen 820. However, the present disclosure is not limited to this embodiment. The process related to the execution of an application other than the cover application or to the setting of the OS may be any process that can be executed on the peripheral device control apparatus 5.

As described above, the function restriction unit 501 according to the embodiment executes the cover application (or the first application) at the startup of the peripheral device control apparatus 5 to cause the display unit 55 to continuously display the cover screen 810 (or the first operation screen) in full screen mode. The cover screen 810 is an operation screen that displays only the minimum necessary operation buttons, such as a “restart” button and a “shut down” button for restarting and shutting down the peripheral device control apparatus 5.

For example, an administrator of the peripheral device control apparatus 5 may start a tool (or an application) other than the cover application or change the settings of the OS to perform maintenance. For this purpose, the function restriction unit 501 according to the embodiment further displays, on the cover screen 810, an operation button (in the present embodiment, the “return to Windows” button 815) for terminating the cover application or the continuous full-screen display of the cover screen 810. To enable only the administrator to terminate the cover application, the function restriction unit 501 according to the embodiment performs authentication by, for example, requesting an input of a password on the authentication screen 820 displayed in full screen mode or as a pop-up window.

With the configuration in which the cover screen 810 is continuously displayed in full screen mode at the startup of the peripheral device control apparatus 5, operations other than those related to the operation buttons included in the cover screen 810 can be prevented. In other words, according to the above-described configuration, it is possible to prevent the OS and applications other than the cover application from displaying operation screens. That is, according to the above-described configuration, it is possible to disable input operations performed by the operator on operation screens related to other applications and the settings of the OS. Therefore, according to the configuration of the embodiment, in the peripheral device control apparatus 5 (or an information processing apparatus) that is operable via a screen and connects the portable POS terminal 3 to the peripheral devices 7, it is possible to restrict operations performed by operators other than a specific operator and prevent unauthorized operations performed by the operators other than the specific operator.

The above embodiment makes it possible to prevent unauthorized operations on the peripheral device control apparatus 5 (or an information processing apparatus) that is operable via a screen and connects the portable POS terminal 3 to the peripheral devices 7.

Control programs executed by the components of the POS system 1 of the present embodiment may be stored in a storage medium such as a ROM.

Control programs executed by the components of the POS system 1 of the present embodiment may be provided on a computer-readable recording medium, such as a CD-ROM, a flexible disk (FD), a CD-R, or a digital versatile disk (DVD), in the form of installable or executable files.

Also, control programs executed by the components of the POS system 1 of the present embodiment may be stored in a computer connected to a network, such as the Internet, and may be downloaded via the network. Furthermore, control programs executed by the components of the POS system 1 of the present embodiment may be provided or distributed via a network such as the Internet.

The control program 581 executed by the peripheral device control apparatus 5 of the present embodiment may have a module configuration including the above-described functional units (the function restriction unit 501, the connection management unit 502, and the maintenance management unit 503). The CPU of the control unit 57 reads the control program 581 from the storage medium and loads the functional units into a main storage device such as the RAM of the control unit 57. As a result, the above-described functional units are generated on the main storage device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus, comprising:
a connection interface connectable to an external device and a peripheral device;
a display;
an input interface; and
a processor configured to:
start an operation system, and
when the operation system is started or the peripheral device is connected to the connection interface, execute a first application, which causes the display to continuously display a first operation screen in full screen mode before displaying a second operation screen of the operation system or another application installed in the information processing apparatus.

2. The information processing apparatus according to claim 1, wherein
the processor is configured to execute the first application immediately after the operation system is started so that the first operation screen is displayed before the second operation screen through which a setting of the operation system can be changed.

3. The information processing apparatus according to claim 1, wherein
the processor is configured to execute the first application immediately after the peripheral device is connected to the connection interface so that the first operation screen is displayed before the second operation screen through which an operation for using said another application can be input.

4. The information processing apparatus according to claim 1, wherein
the first operation screen includes a first operation button for restarting the information processing apparatus, a second operation button for shutting down the information processing apparatus, and a third operation button for displaying the second operation screen.

5. The information processing apparatus according to claim 4, wherein
the processor is configured to:
cause the display to display an authentication screen when the third operation button is operated via the input interface, and
cause the display to stop continuously displaying the first operation screen in full screen mode when authentication is successfully done through the authentication screen.

6. The information processing apparatus according to claim 5, wherein
the processor is configured to accept, via the input interface, an operation for using said another application or changing a setting of the operating system after the authentication is successfully done.

7. The information processing apparatus according to claim 1, wherein
the connection interface includes
a wireless network interface wirelessly connectable to the external device, and
an input/output interface connectable to the peripheral device.

8. The information processing apparatus according to claim 7, wherein
the processor is configured to cause the display to stop continuously displaying the first operation screen in full screen mode when the peripheral device is disconnected from the input/output interface.

9. The information processing apparatus according to claim 8, wherein
the processor is configured to accept, via the input interface, an operation for using said another application or changing a setting of the operating system after the peripheral device is disconnected.

10. The information processing apparatus according to claim 8, wherein
the external device is a portable point-of-sale (POS) terminal.

11. A point-of-sale (POS) system, comprising:
a portable POS terminal;
a peripheral device; and
a control apparatus connectable to the POS terminal and the peripheral device and configured to:
start an operation system, and
when the operation system is started or the peripheral device is connected to the control apparatus, execute a first application, which continuously displays a first operation screen in full screen mode before displaying a second operation screen of the operation system or another application installed in the control apparatus.

12. The POS system according to claim 11, wherein
the control apparatus is configured to execute the first application immediately after the operation system is started so that the first operation screen is displayed before the second operation screen through which a setting of the operation system can be changed.

13. The POS system according to claim 11, wherein
the control apparatus is configured to execute the first application immediately after the peripheral device is connected to the control apparatus so that the first operation screen is displayed before the second operation screen through which an operation for using said another application can be input.

14. The POS system according to claim 11, wherein
the first operation screen includes a first operation button for restarting the control apparatus, a second operation button for shutting down the control apparatus, and a third operation button for displaying the second operation screen.

15. The POS system according to claim 14, wherein
the control apparatus is configured to:
display an authentication screen when the third operation button is operated, and
stop continuously displaying the first operation screen in full screen mode when authentication is successfully done through the authentication screen.

16. The POS system according to claim 15, wherein
the control apparatus is configured to accept an operation for using said another application or changing a setting of the operating system after the authentication is successfully done.

17. The POS system according to claim 11, wherein
the control apparatus includes
a wireless network interface wirelessly connectable to the POS terminal, and
an input/output interface connectable to the peripheral device.

18. The POS system according to claim 17, wherein
the control apparatus is configured to stop continuously displaying the first operation screen in full screen mode when the peripheral device is disconnected from the input/output interface.

19. The POS system according to claim 18, wherein
the control apparatus is configured to accept an operation for using said another application or changing a setting of the operating system after the peripheral device is disconnected.

20. A method performed by an information processing apparatus connectable to an external device and a peripheral device, the method comprising:
starting an operation system; and
when the operation system is started or the peripheral device is connected to the information processing apparatus, executing a first application, which continuously displays a first operation screen in full screen mode before displaying a second operation screen of the operation system or another application installed in the information processing apparatus.
